(19) United States
(12) Patent Application Publication
(10) Pub. No.: US 2018/0112835 A1
(43) Pub. Date: Apr. 26, 2018

(54) LAMP AND METHOD FOR PRODUCING A LAMP

(71) Applicant: OSRAM GmbH, Munich (DE)

(72) Inventors: József SZÉKELY, Gannertshofen (DE); Sven SEIFRITZ, Herbrechtingen (DE); Oliver WOISETSCHLAEGER, Sontheim (DE)

(21) Appl. No.: 15/560,523

(22) PCT Filed: Mar. 9, 2016
(86) PCT No.: PCT/EP2016/054959

§ 371 Date: Sep. 22, 2017

(30) Foreign Application Priority Data
Mar. 24, 2015 (DE) 10 2015 205 352.0

(51) Int. Cl. F21K 9/27; F21V 19/00; F21V 23/00; F21K 9/61; F21V 8/00

(52) U.S. Cl. CPC F21K 9/27; F21V 19/003; F21Y 2115/10; F21K 9/61; G02B 6/001; F21V 23/001

(57) ABSTRACT

According to the present disclosure, a lamp is provided including a sleeve-shaped lamp housing, and a plurality of mounting plates including a light source wherein the mounting plates are configured to be arranged on a respective housing end of said lamp housing, wherein the mounting plates are connected in an electrical manner by way of at least one connecting element. The connecting element is pressed in with at least one end section into an orifice of one of the mounting plates so as to provide the electrical connection and a mechanical retaining arrangement.

### RELATED APPLICATIONS

The present application is a national stage entry according to 35 U.S.C. § 371 of PCT application No. PCT/EP2016/054959 filed on Mar. 9, 2016, which claims priority from German application No. 10 2015 205 352.0 filed on Mar. 24, 2015, and is incorporated herein by reference in its entirety.

### TECHNICAL FIELD

The present disclosure relates to a lamp, in particular a festoon lamp, in accordance with the preamble of claim 1. Furthermore, the present disclosure relates to a method for producing such a lamp.

### BACKGROUND

Document WO 2013/127557 A1 discloses such a lamp or festoon lamp. This has a sleeve-shaped lamp housing onto which is placed at each end a mounting plate having a semi-conductor light source. The semi-conductor light sources can thus radiate light into the lamp housing. The lamp housing is sealed by way of metal sleeves, wherein the mounting plates are arranged in each case in a respective metal sleeve. Wires are provided in order to connect the mounting plates in an electrical manner to one another and a respective wire is inserted and soldered into an orifice in a respective mounting plate. In addition to the semi-conductor light sources, further electronic components are provided on the mounting plates. One disadvantage of this solution is that it is extremely difficult to solder the wires to the mounting plate, the reason being that the installation space is small and/or the spatial conditions narrow as a result of the electronic construction elements (or components) and the semi-conductor light source. Furthermore, it is extremely time-consuming and costly to supply and mount the wires.

Festoon lamps are also known from the prior art, wherein the semi-conductor light source is provided on one face of a respective mounting plate and a cooling body is provided on the respective other face (rear face). Furthermore, festoon lamps are known that require a small amount of current and thus also experience a small power loss, for which reason said festoon lamps are not required to fulfill high demands, such as for example providing feedback so as to avoid a total failure of the festoon lamp.

### SUMMARY

The object of the present disclosure is to provide a lamp that is equipped in a simple manner as far as the technical aspects of the device are concerned and can be produced in a time-saving and cost-effective manner. A further object of the present disclosure is to provide a method with which such a lamp can be produced in a simple and cost-effective manner.

This object is achieved with respect to the lamp in accordance with the features of claim 1 and with respect to the method in accordance with the features of claim 11.

Particularly advantageous embodiments are disclosed in the dependent claims.

In accordance with the present disclosure, a lamp is provided, said lamp being in particular a festoon lamp and/or in particular an LED retrofit having a press-fit contacting arrangement, having a sleeve-shaped, in particular cylindrical or tube-shaped lamp housing. A mounting plate is arranged at each housing end of the lamp housing, said mounting plate being in particular a circuit board or a printed circuit board and having a light source that can radiate light into the lamp housing. The mounting plates are connected in an electrical and mechanical manner to one another by way of at least one connecting element. The connecting element is advantageously pressed with at least one end section into an orifice, in particular a bore hole or through-going bore hole in one of the mounting plates so as to provide the electrical and mechanical connection.

This solution has the advantage that as a result of the connecting element being pressed in, it is no longer necessary to provide solder so as to create the electrical connection and mechanical fastening. This leads in turn to the fact that in comparison to soldering the components, in this solution the components can be arranged closer to the pressed-in connecting site between the connecting element and the mounting plate, the reason being that there is no risk of a short circuit which could be caused by an inferior or poor solder joint. Consequently, the pressed-in end sections of the connecting element are advantageously not soldered, such solder joints can cause the lamp to fail sporadically and by way of example can also on occasions cause so-called solder pearls to form that are not obvious to a visual inspection. As a consequence, by virtue of the fact that the connecting element is pressed-in, a greater degree of process reliability is achieved during the production process and also the procedure of assembling the lamp is considerably simpler.

In a further embodiment of the present disclosure, the connecting element is pressed by means of its two end sections in each case into an orifice of a respective mounting plate. The mounting plates are subsequently connected to one another together with the lamp housing in a sandwich-like manner by way of the connecting element or by way of multiple connecting elements by means of the pressing-in arrangement.

It is preferred that this connecting element or a plurality of connecting elements extend within the sleeve-shaped lamp housing.

In a further embodiment of the present disclosure, the connecting element is configured as an, in particular bend-resistant, connecting peg or connecting pin. Such a connecting pin is easy to handle in comparison to a wire and can be loaded by way of example in its axial direction for the pressing-in procedure.

It is preferred that a press-in connection is configured as a press-fit connection.

It is preferred that the orifice in the mounting plate or the orifices in the mounting plates include in each case a metalized wall so as to be able to produce the electrical contact with the connecting element in a simple manner. It is preferred that, in order to achieve sufficient pressing force, the end section or a respective end section of the connecting element is configured in a resilient and/or elastic deformable manner for the pressing-in procedure.

It is preferred that the connecting elements are pressed into the mounting plates in a detachable manner, which renders it possible to remove the lamp in a simple manner for repair work or for re-cycling.

It is preferred that the light sources that are mounted on the respective mounting plates are semi-conductor light sources, wherein in addition electronic components can be provided on one or both mounting plates. The pressed-in connecting elements are extremely advantageous, the reason being that, as already explained above, as a result of the electronic components an extremely small amount of installation space is available and this is extremely disadvantageous for a soldering procedure.

In a further embodiment of the present disclosure, the light source is a light-emitting diode (LED). An LED can be provided in the form of at least one individually housed light diode or in the form of at least one LED chip. As an alternative or in addition thereto, multiple LED chips can be mounted on a common substrate (“submount”). The at least one light diode can be equipped with at least one dedicated and/or common lens for directing the light beam, for example at least one Fresnel lens, collimator, etc. In lieu of or in addition to inorganic light diodes, for example on the basis of InGaN or AlInGaP, it is also possible in general to use organic LEDs (OLEDs, for example polymer OLEDs). As an alternative, the light-emitting diode (LED) can be a laser diode or a laser diode arrangement. The emission wavelengths of the light-emitting diodes (LED) can be in the ultra-violet, visible or infrared spectral range.

The lamp housing is advantageously embodied at least in part or entirely from a synthetic material and is produced by means of an injection molding process. This renders it possible in a cost-effective and simple manner for the lamp housing to be injection-molded around one connecting element, multiple connecting elements or all connecting elements by means of the injection molding process. The mounting plates can be subsequently assembled in an extremely simple manner in a so-called “plug and play” procedure, in that said mounting plates are simply placed on the lamp housing with the connecting elements. This considerably reduces the time required for assembling the lamp.

It is preferred that the lamp housing encompasses the connecting element or a respective connecting element by means of a radial inner retaining protrusion. As a result of the connecting elements being injection molded and/or encased, said connecting elements are in addition mechanically supported during the procedure of assembling the lamp.

It is preferred that the lamp housing is configured as a lens.

Furthermore, it is advantageous if at least three connecting elements are provided, said connecting elements being connected to a respective mounting plate in a press-fit arrangement by way of their respective end sections.

The mounting plates are advantageously arranged by way of a so-called “poka yoke system”, whereby said mounting plates include by way of example a shape coding for mating with the lamp housing so that they can only be arranged in a predetermined position on the lamp housing.

An axial length of one connecting element or multiple connecting elements or all connecting elements is advantageously greater than an axial length of the lamp housing, whereby the connecting element that is embodied in such a manner can protrude with both end sections out of the lamp housing and the mounting plates can thus be assembled in a simple manner.

The mounting plates can lie at least in sections and/or be supported in each case on an end face, in particular on an annular end face, of the lamp housing.

The connecting element or the connecting elements is or are advantageously arranged spaced slightly apart in a parallel manner with respect to the longitudinal axis of the lamp housing.

A respective light source can be arranged approximately in the middle of its mounting plate, wherein the connecting element or the connecting elements are provided in a radially outwards offset manner with respect to the respective light source.

Furthermore, it is feasible that a particular mounting plate that is metalized in particular in the sheath region and is in particular part of the electrical path is covered by an end sleeve at least in sections. The respective end sleeve can be mechanically and/or electrically connected to a respective mounting plate advantageously by way of one press-fit arrangement multiple press-fit arrangements or advantageously by way of in each case four press-fit arrangements, wherein the procedure is in particular a so-called “hit point connection”. The end sleeves can thus be held by way of these connections against the mounting plate and the mounting plates can be held together with the lamp housing in a sandwich-like manner by way of the connecting elements that are arranged between said components, this renders possible an extremely simple construction of the lamp.

In a further embodiment of the present disclosure, the lamp housing includes on each end an external circumferential step, whereby two annular end faces are formed at the end respectively. It is subsequently possible to place on a respective step a respective end sleeve, wherein the respective mounting plate is arranged in each case in the region of the inner annular end face.

In the case of the method in accordance with the present disclosure for producing a lamp in accordance with one of the preceding aspects, the lamp housing is produced by means of an injection molding process. The lamp housing is subsequently injection molded around one connecting section or multiple connecting sections.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 illustrates a longitudinal sectional view of a lamp in accordance with the present disclosure according to a first embodiment,

FIG. 2 illustrates a longitudinal sectional view of the lamp in accordance with the present disclosure according to a second embodiment,

FIG. 3 illustrates a longitudinal sectional view of a further illustration of the lamp according to the second embodiment,

FIG. 4 illustrates a lateral view of the lamp in accordance with the present disclosure.

### DETAILED DESCRIPTION

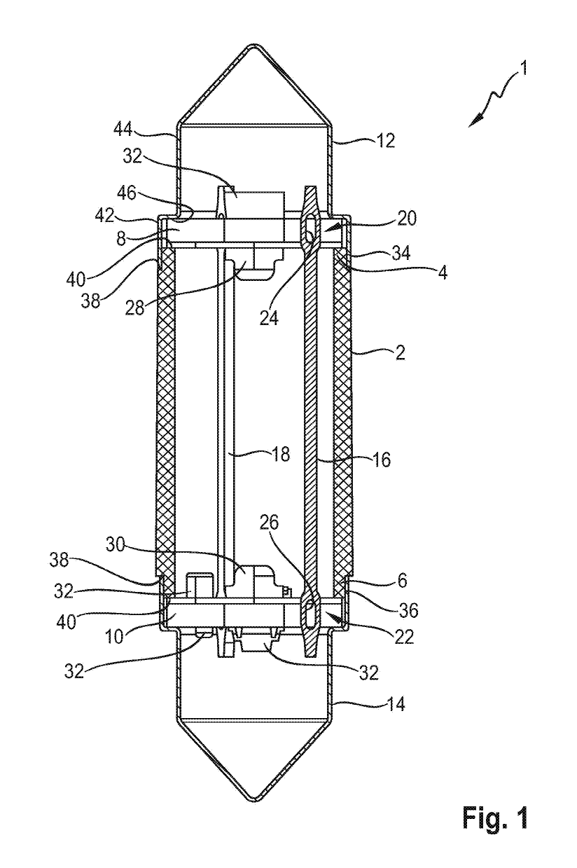

A lamp in the form of a festoon lamp 1 is illustrated in accordance with FIG. 1. Said lamp has an approximately cylindrical, in particular approximately circular cylindrical, lamp housing 2 that is embodied from a synthetic material and forms a lens. A mounting plate in the form of a printed circuit board 8 or 10 is arranged in each case on the first and second housing end 4 and 6. A respective printed circuit board 8 and 10 and also the housing ends 4 and 6 are encased in each case by a metal end sleeve 12, 14. In order to connect the printed circuit boards 8, 10 to one another in an electrical and mechanical manner, three connecting elements in the form of connecting pins 16, 18 are provided and two of said connecting pins are illustrated in FIG. 1. A respective connecting pin 16, 18 has two end sections 20, 22 that are pressed in each case into an orifice 24 or 26 in the respective printed circuit board 8 or 10. Consequently, a respective printed circuit board 8 and 10 includes in each case three orifices 24, 26 for the three connecting pins 16, 18.

The three metal connecting pins 16, 18 are arranged on a part circle and extend spaced slightly apart in a parallel manner with respect to the longitudinal axis of the festoon lamp 1. A respective connecting pin 16, 18 is configured approximately with a square-shaped cross section between the end sections 20 and 22. In order to facilitate the pressing-in procedure, the end sections 20 and 22 of a respective connecting pin 16, 18 are configured in such a manner that they widen and include a through-going cutout, whereby the end section 20 and 22 have a resilient characteristic. The end sections 20 or 22 can consequently be inserted into the orifice 24 or 26 respectively in a resilient manner using a pressing force. A respective connecting pin 16, 18 hereby passes through the printed circuit boards 8 or 10 respectively and as a result said connecting pin protrudes in a direction away from the lamp housing 2 into an inner space of the respective end sleeve 12 or 14.

An LED 28 or 30 respectively is arranged in the middle of a respective printed circuit board 8 and 10 and said LEDs face one another and protrude into the lamp housing 2. Furthermore, electronic components 32 are arranged on one or both faces of a respective printed circuit board 8 and 10.

The lamp housing 2 includes on its housing ends 4, 6 in each case a radial, outer backwards stepping arrangement 34 or 36, whereby in each case a step is formed. The lamp housing 2 subsequently has at its housing ends 4 and 6 in each case an outer and an inner annular end face 38, 40. The respective printed circuit board 8, 10 lies with its face that is facing the lamp housing 2 against a respective inner annular end face 40.

The bush-shaped end sleeves 12, 14 have in each case a lamp housing-side section 42 and a section 44 that is adjacent to said housing-side section. The lamp housing-side section 42 has a greater diameter than the section 44, as a result of which a step is formed that has an inner annular face 46 that faces the lamp housing 2. A respective printed circuit board 8 or 10 can lie at least in sections against said annular face.

In order to connect the end sleeves 12 and 14 in an electrical manner to the respective printed circuit board 8 or 10 and to retain the end sleeves 12 and 14 in a mechanical manner against the respective printed circuit board 8 or 10, after the end sleeves 12 and 14 have been assembled, four point press-fit arrangements or press-ins, which is described as a “hit-point process” are produced radially around the section 42. As a consequence, the printed circuit boards 8, 10 are held against the lamp housing 2 by way of the connecting pins 16, 18 and the end sleeves 12, 14 are in turn held against the printed circuit boards 8, 10 by way of the pressing-in arrangement.

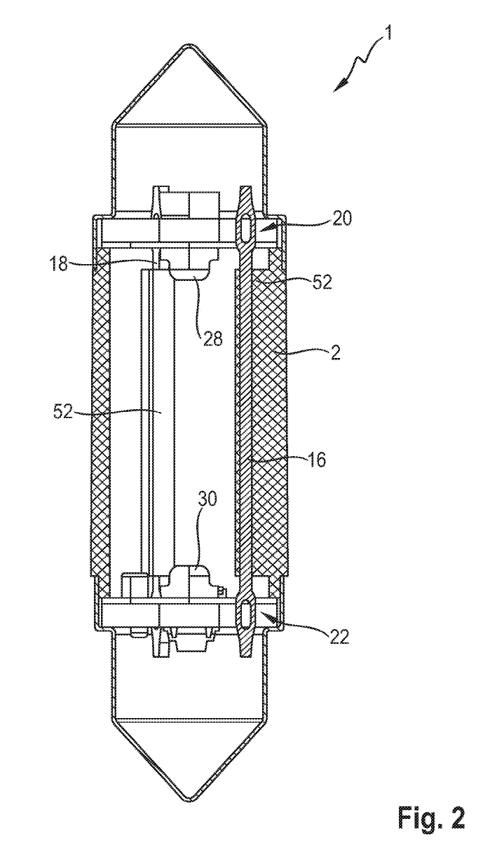

FIG. 2 illustrates the festoon lamp 1, wherein in contrast to FIG. 1, the lamp housing 2 has been injection molded in sections around the connecting pins 16, 18. The lamp housing 2 includes for this purpose for a respective connecting pin 16, an axially extending connecting piece 52 that protrudes into the inside of the lamp housing 2. A respective connecting piece 52 is subsequently completely penetrated in the axial direction by the respective connecting pin 16, 18, as a result of which a respective connecting pin 16, 18 protrudes with its end sections 20 out of the respective connecting piece 52. The connecting pieces 52 are configured in such a manner that they are spaced apart in the radial direction from the LEDs 28 and 30.

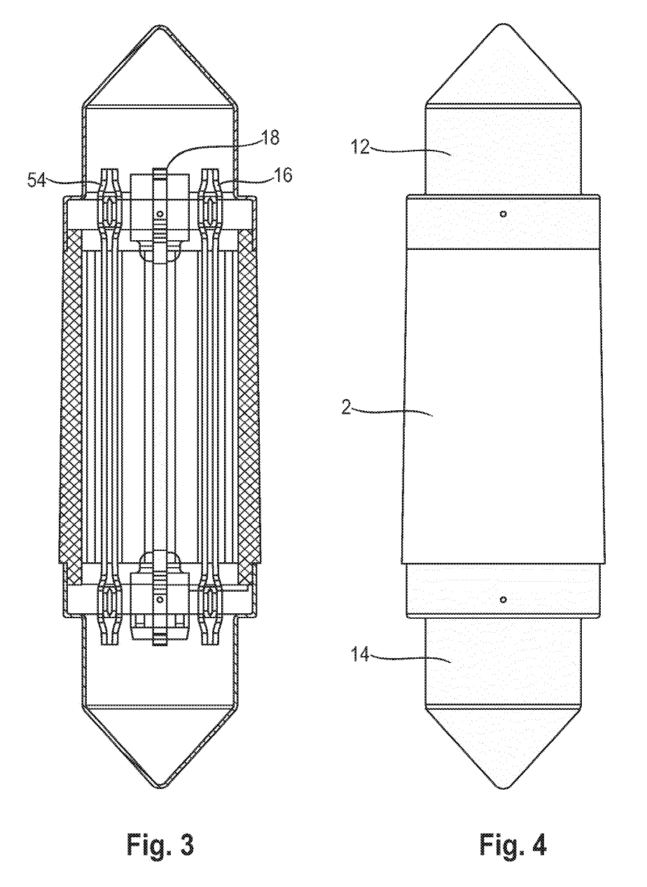

FIG. 3 illustrates three connecting pins 16, 18 and 54.

It is evident in FIG. 4 that the end sleeves 12, 14 are connected to the lamp housing 2 in a flush manner or with a desired gap, a so-called shadow gap.

A festoon lamp is disclosed that includes a sleeve-shaped lamp housing, wherein a printed circuit board having a light source is provided at each end. In order to connect the printed circuit boards to one another in an electrical and/or mechanical manner, connecting elements are provided between the printed circuit boards and said connecting elements are pressed into the printed circuit board. The connecting elements can be individual pins that are connected to the printed circuit boards by way of a press-fit connection.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A lamp comprising a sleeve-shaped lamp housing, and a plurality of mounting plates comprising a light source wherein the mounting plates are configured to be arranged on a respective housing end of said lamp housing, wherein the mounting plates are connected in an electrical manner by way of at least one connecting element, and wherein the connecting element is pressed in with at least one end section into an orifice of one of the mounting plates so as to provide the electrical connection and a mechanical retaining arrangement.

2. The lamp as claimed in claim 1, wherein the connecting element is configured to be pressed in with its two end sections respectively into an orifice of the respective mounting plate.

3. The lamp as claimed in claim 1, wherein the connecting element is configured as a connecting pin.

4. The lamp as claimed in claim 1, wherein the electrical connection and the mechanical retaining arrangement between the connecting element and at least one mounting plate is configured as a press-fit connection.

5. The lamp as claimed in claim 1, wherein the end section or a respective end section of the connecting element is configured so as to be able to deform in a resilient manner.

6. The lamp as claimed in claim 1, wherein the light sources that are mounted on a respective mounting plate are semi-conductor light sources and in addition electronic components are provided on one or both mounting plates.

7. The lamp as claimed in claim 1, wherein the lamp housing is embodied at least in part or entirely from a synthetic material and is produced by means of an injection molding process, wherein the lamp housing is injection molded around one connecting element or multiple connecting elements by means of the injection molding process.

8. The lamp as claimed in claim 1, wherein the lamp housing encompasses the connecting element or a respective connecting element by means of a radial inner retaining protrusion.

9. The lamp as claimed in claim 1, wherein at least three connecting elements are provided that are connected to a respective mounting plate in a press-fit arrangement by way of their respective end sections.

10. The lamp as claimed in claim 1, wherein a respective mounting plate is covered at least in sections by an end sleeve, and wherein a respective end sleeve is fixedly connected in a mechanical manner and/or connected in an electrical manner to a respective mounting plate by way of a press-fit arrangement.

11. A method for producing a lamp in accordance with claim 1, wherein the lamp housing is produced by means of an injection molding process, wherein the lamp housing is injection molded around one connecting element or multiple connecting elements.
